(19) United States
(12) Patent Application Publication
(10) Pub. No.: US 2017/0077720 A1
(43) Pub. Date: Mar. 16, 2017

(54) SYSTEMS AND METHODS FOR ADAPTIVE FAST-CHARGING FOR MOBILE DEVICES AND DEVICES HAVING SPORADIC POWER-SOURCE CONNECTION

(71) Applicant: StoreDot Ltd., Herzeliya (IL)

(72) Inventors: Daniel ARONOV, Netanya (IL); Leonid Krasovitsky, Rishon LeTzion (IL)

(21) Appl. No.: 15/287,292

(22) Filed: Oct. 6, 2016

Related U.S. Application Data
(63) Continuation-in-part of application No. 14/675,771, filed on Apr. 1, 2015.
(60) Provisional application No. 61/976,551, filed on Apr. 8, 2014.
(60) Provisional application No. 62/238,515, filed on Oct. 7, 2015.

(51) Int. Cl. H02J 7/00

(52) U.S. Cl. CPC H02J 7/007; H02J 7/0021; H02J 7/0045

(57) ABSTRACT

The present invention discloses systems and methods for adaptive fast-charging for mobile devices and devices having sporadic power-source connection. Methods include the steps of: firstly determining whether a supercapacitor of a device is charged; upon detecting the supercapacitor is charged, secondly determining whether a battery of the device is charged; and upon detecting the battery is not charged, firstly charging the battery from the supercapacitor. Preferably, the step of firstly determining includes whether the supercapacitor is partially charged, and the step of secondly determining includes whether the battery is partially charged. Preferably, the step of firstly charging is adaptively regulated to perform a task selected from the group consisting of: preserving a lifetime of the battery by controlling a current to the battery, and discharging the supercapacitor in order to charge the battery. Preferably, the discharging enables the supercapacitor to be subsequently recharged.

### CROSS REFERENCE TO RELATED APPLICATIONS

This patent application is a continuation-in-part application of co-pending U.S. patent application Ser. No. 14/675,771, filed on Apr. 1, 2015, which claims priority to and the benefit of, under 35 U.S.C. §119(e) to U.S. Provisional Patent Application No. 61/976,551 filed Apr. 8, 2014 and U.S. Provisional Patent Application No. 62/238,515 filed Oct. 7, 2015, all of which are incorporated herein by reference in their entireties.

### FIELD AND BACKGROUND OF THE INVENTION

The present invention relates to systems and methods for adaptive fast-charging for mobile devices and devices having sporadic power-source connection.

Modern electronic appliances are becoming ubiquitous for personal as well as business use. It cannot be overstated that with the evolution of such devices, mobility has emerged as a key driver in feature enhancement for technological innovation. While the rapid advancement of low power-consumption processors and flash-memory devices have enabled such mobility to reach new levels of real-world productivity, further development is significantly hampered by the rather slow progress made in battery technology. The proliferation of smart phones, tablets, laptops, ultrabooks, and the like (acquiring smaller and smaller form factors) has made this issue even more abundantly apparent as consumers are eager to have longer and longer device usage times between recharge cycles, without adding heft to the weight and footprint of such devices.

Furthermore, electrical and electronic components that don't fall under the mobile rubric are also in need of extended usage solutions. Such components include devices having sporadic power-source connection (e.g., backup emergency sentinels, remotely-stationed telecommunication repeaters, electric vehicle console communicators, as well as off-shore communication, control, and positioning devices).

The demands of such applications vary widely, for example, in voltage or power level, but all are preferably served by lightweight, power-storage devices which can rapidly and consistently provide high energy density over long time spans, and can be quickly recharged to operational energy levels. To date, such extensive mobile energy needs are being met in part by one of two available types of power-storage devices: rechargeable batteries (e.g., lithium-ion intercalation systems) or supercapacitors (e.g., Faradic pseudo-capacitive type, non-Faradic double-layer reaction types, or hybrid types).

To meet the growing demand in portable electronic devices and devices having sporadic power-source connection, energy storage devices with high specific energy, high power density, long cycle life, low cost, and a high margin of safety must be employed.

Typically, consumers of rechargeable devices do not want to wait a long time for devices to charge. For example, for a consumer using a mobile phone on a business trip, it may not be possible for the consumer to wait a half an hour to have enough battery power to make an important phone call.

Currently, the dominant energy storage device remains the battery, particularly the lithium-ion battery. Lithium-ion batteries power nearly every portable electronic device, as well as almost every electric car, including the Tesla Model S and the Chevy Volt. Batteries store energy electrochemically, in which chemical reactions release electrical carriers that can be extracted into an electrical circuit. During discharge, the energy-containing lithium ions travel from a high-energy anode material through a separator to a low-energy cathode material. The movement of the lithium ions releases energy, which is extracted into an external circuit.

During battery charging, energy is used to move the lithium ions back to the high-energy anode compound. The charge and discharge process in batteries is a slow process, and can degrade the chemical compounds inside the battery over time. A key bottleneck in achieving enhanced performance is the limited fast-charging ability of any standard battery. Rapid charging causes accelerated degradation of the battery constituents, as well as a potential fire hazard due to a localized, over-potential build-up and increased heat generation.

For example, Li-ion batteries have the highest energy density of rechargeable batteries available, but typically suffer from low power by virtue of reversible Coulombic reactions occurring at both electrodes, involving charge transfer and ion diffusion in bulk electrode materials. Since both diffusion and charge transfer are slow processes, power delivery as well as the recharge time of Li-ion batteries is kinetically limited. As a result, batteries have a low power density, and lose their ability to retain energy throughout their lifetime due to material degradation.

On the other extreme, electrochemical double-layer capacitors (EDLCs) or ultracapacitors are, together with pseudocapacitors, part of a new type of electrochemical capacitors called supercapacitors (hereinafter referred to as SCs), which store energy through accumulation of ions on an electrode surface, have limited energy storage capacity, but very high power density. In such SCs, energy is stored electrostatically on the surface of the material, and does not involve a chemical reaction. As a result, SCs can be charged quickly, leading to a very high power density, and do not lose their storage capabilities over time. SCs can last for millions of charge/discharge cycles without losing energy storage capability. The main shortcoming of SCs is their low energy density, meaning that the amount of energy SCs can store per unit weight is very small, particularly when compared to batteries.

The most intuitive approach to combine high energy and high power density within a single device is to combine different types of energy storage sources. So far, such hybrid power-source devices involving SCs and batteries have mainly been explored in view of parallel connection (i.e., an SC is being used as a power supply, while the battery is used as an energy source, which supplies energy both to the load and to the SC, which in turn, should be charged at all times). The contribution of components to the total stored charge is not optimal, due to the minimal use of the SC, and the higher degradation of the battery due to the additional charging of the SC.

In the prior art, Kan et al. published findings (Journal of Power Sources, 162(2), 971-974, 2006) analyzing combinations of rechargeable batteries and capacitors in storage media of photovoltaic-powered products. In such applications, the focus of the study was to reduce power cycling of the batteries by utilizing a well-defined recharge duty cycle.

Buiel et al. published findings at the Capacitor and Resistor Technology Symposium (CARTS International 2013) on development of ultrathin ultracapacitors for enhanced lithium batteries in portable electronic applications. The focus of the study was to extend the usable energy stored on lithium batteries by compensating for voltage droop during GSM radio pulses by employing an SC to discharge to the lithium battery when the low-voltage cutoff of the main battery is reached. Similarly, this was also partly the subject of International Patent Publication No. WO/2006/112698 for a rechargeable power supply.

It would be desirable to have systems and methods for adaptive fast-charging for mobile devices and devices having sporadic power-source connection. It is also desirable to reduce the cost of fast charging batteries. Such systems and methods would, inter alia, overcome the various limitations mentioned above.

### SUMMARY

It is the purpose of the present invention to provide systems and methods for adaptive fast-charging for mobile devices and devices having sporadic power-source connection.

It is noted that the term “exemplary” is used herein to refer to examples of embodiments and/or implementations, and is not meant to necessarily convey a more-desirable use-case. Similarly, the terms “preferred” and “preferably” are used herein to refer to an example out of an assortment of contemplated embodiments and/or implementations, and is not meant to necessarily convey a more-desirable use-case. Therefore, it is understood from the above that “exemplary” and “preferred” may be applied herein to multiple embodiments and/or implementations.

Preferred embodiments of the present invention enable adaptive fast-charging of mobile devices and devices having sporadic power-source connection by incorporating high-energy SCs in combination with rechargeable batteries, allowing for higher system power, while preserving the energy density of the battery in a device-compatible form factor.

Features of such adaptive fast-charging systems and methods include, inter alia the following aspects.
Fast charging (e.g., due to SC and/or fast charging battery cell properties)
Adaptive charging intervals (e.g., via control of battery charging characteristics)
Standard working time (e.g., using 1500mAh for both fast charge and rechargeable battery, talk time supplied is about 20 hours)
High energy density (e.g., due to intrinsic battery and/or the fast charging battery cell properties, having an exemplary density range of 450 Wh/l to 700 Wh/l)
High power density (due to intrinsic SC properties and/or due to intrinsic Flashbattery properties, having an exemplary power density range of 5400 W/l to 7200 W/l)
Battery lifetime improvement (via control of battery charging characteristics for example, from 500 cycles for standard mobile device battery to more than 1500 cycles)
High current input allowed (e.g., from 10 A to 25 A) The system, that includes the connector, power management control done by the controller, metal conductive wires, electronic components for delivering current, can allow for the option of delivering high current to the fast charging battery.
Adaptive battery charging by controlling the current (e.g., control of the current into the rechargeable battery, cycle life of the rechargeable battery can be improved. In general, standard rechargeable battery's cycle life gets higher as charging current is lower)
Substantially, no overheating due to high charging current (e.g., due to very low internal resistance of fast charging battery cell properties, and/or battery charging is controlled, e.g., from 1-10 mOhm for internal resistance)
Can't be overcharged (SC can't be overcharged, and battery charging is controlled)
Can't be overheated (SC can't be overheated, and battery charging is controlled)
Low self-discharge (e.g., energy is accumulated in battery, with low intrinsic discharge properties and/or fast charging battery cell properties can have the same self-discharge characteristic as standard Li ion battery, the low self-discharge in the exemplary range of 5% in 24 h, then 1-2% per month).

Therefore, according to the present invention, there is provided a method for adaptive fast-charging for mobile devices and devices having sporadic power-source connection, the method including the steps of: (a) firstly determining whether a supercapacitor of a device is charged; (b) upon detecting the supercapacitor is charged, secondly determining whether a battery of the device is charged; and (c) upon detecting the battery is not charged, firstly charging the battery from the supercapacitor.

Preferably, the step of firstly determining includes determining whether the supercapacitor is partially charged, and the step of secondly determining includes determining whether the battery is partially charged.

Preferably, the step of firstly charging is adaptively regulated to perform at least one task selected from the group consisting of: preserving a lifetime of the battery by controlling a current to the battery, and discharging the supercapacitor in order to charge the battery.

Most preferably, the discharging enables the supercapacitor to be subsequently recharged.

Preferably, the method further including the steps of: (d) prior to the step of firstly determining, initially determining whether an external charger is connected to the device; and (e) upon detecting the external charger is connected to the device, secondly charging the supercapacitor and/or the battery from the external charger.

Most preferably, the method further including the step of: (f) upon detecting the external charger is not connected to the device, supplying energy to the device from the supercapacitor and/or the battery.

According to the present invention, there is provided a system for adaptive fast-charging for mobile devices and devices having sporadic power-source connection, the system including: (a) a supercapacitor charging controller for firstly determining whether a supercapacitor of a device is charged; and (b) a battery charging controller for secondly determining whether a battery of the device is charged; wherein, upon detecting the supercapacitor is charged and upon detecting the battery is not charged, the supercapacitor charging controller is configured for firstly charging the battery from the supercapacitor.

Preferably, the firstly determining includes determining whether the supercapacitor is partially charged, and the secondly determining includes determining whether the battery is partially charged.

Preferably, the firstly charging is adaptively regulated to perform at least one task selected from the group consisting of: preserving a lifetime of the battery by controlling a current to the battery, and discharging the supercapacitor in order to charge the battery.

Most preferably, the discharging enables the supercapacitor to be subsequently recharged.

Preferably, the supercapacitor charging controller is further configured for: (i) prior to the firstly determining, initially determining whether an external charger is connected to the device; and (ii) upon detecting the external charger is connected to the device, secondly charging the supercapacitor and/or the battery from the external charger.

Most preferably, the supercapacitor charging controller is further configured for: (iii) upon detecting the external charger is not connected to the device, supplying energy to the device from the supercapacitor and/or the battery.

According to the present invention, there is provided a non-transitory computer-readable medium, having computer-readable code embodied on the non-transitory computer-readable medium, the computer-readable code having program code for adaptive fast-charging for mobile devices and devices having sporadic power-source connection, the computer-readable code including: (a) program code for firstly determining whether a supercapacitor of a device is charged; (b) program code for, upon detecting the supercapacitor is charged, secondly determining whether a battery of the device is charged; and (c) program code for, upon detecting the battery is not charged, firstly charging the battery from the supercapacitor.

Preferably, the firstly determining includes determining whether the supercapacitor is partially charged, and the secondly determining includes determining whether the battery is partially charged.

Preferably, the firstly charging is adaptively regulated to perform at least one task selected from the group consisting of: preserving a lifetime of the battery by controlling a current to the battery, and discharging the supercapacitor in order to charge the battery.

Most preferably, the discharging enables the supercapacitor to be subsequently recharged.

Preferably, the computer-readable code comprising further includes: (d) program code for, prior to the firstly determining, initially determining whether an external charger is connected to the device; and (e) program code for, upon detecting the external charger is connected to the device, secondly charging the supercapacitor and/or the battery from the external charger.

Most preferably, the computer-readable code comprising further includes: (f) program code for, upon detecting the external charger is not connected to the device, supplying energy to the device from the supercapacitor and/or the battery.

These and further embodiments will be apparent from the detailed description that follows.

### BRIEF DESCRIPTION OF THE DRAWINGS

The present invention is herein described, by way of example only, with reference to the accompanying drawing, wherein:

FIG. 1 is a simplified high-level schematic diagram of the device architecture for adaptive fast-charging for mobile devices and devices having sporadic power-source connection, according to preferred embodiments of the present invention;

FIG. 2 is a simplified flowchart of the major process steps of an SC controller for adaptive fast-charging for mobile devices and devices having sporadic power-source connection, according to preferred embodiments of the present invention;

FIG. 3 is a simplified flowchart of the major process steps of a battery controller for adaptive fast-charging for mobile devices and devices having sporadic power-source connection, according to preferred embodiments of the present invention;

FIG. 4 is a simplified flowchart of the major process steps of a device interface controller for adaptive fast-charging for mobile devices and devices having sporadic power-source connection, according to preferred embodiments of the present invention;

FIG. 5A is a graph of a typical Li-ion battery charge curve, as known in the prior art;

FIG. 5B is a graph of a typical Li-ion battery discharge curve, as known in the prior art;

FIG. 6A is a graph of a typical SC charge curve, as known in the prior art;

FIG. 6B is a graph of a typical SC discharge curve, as known in the prior art;

FIG. 7 is a graph of a FlashBattery charge/discharge simulation in accordance with the simulation parameters of Table 1, according to preferred embodiments of the present invention;

FIG. 8 is a graph of a FlashBattery charge/discharge simulation in accordance with the simulation parameters of Table 2, according to preferred embodiments of the present invention;

FIG. 9 is a graph of a FlashBattery charge/discharge simulation in accordance with the simulation parameters of Table 3, according to preferred embodiments of the present invention;

FIG. 10 is a graph of a FlashBattery charge/discharge simulation in accordance with the simulation parameters of Table 4, according to preferred embodiments of the present invention;

FIG. 11 is a graph of a FlashBattery charge/discharge simulation in accordance with the simulation parameters of Table 5, according to preferred embodiments of the present invention.

FIG. 12 is a schematic diagram of an architecture for a device for providing power to the device, according to an illustrative embodiment of the invention.

FIG. 13 is a flowchart of a method for providing power to a device, according to an illustrative embodiment of the invention.

FIG. 14 is a flowchart of a method for charging batteries of a device when the device is connected to an external power source, according to an illustrative embodiment of the invention.

FIG. 15 is a flowchart of a method for charging batteries of a device when the device is not connected to an external power source, according to an illustrative embodiment of the invention.

FIG. 16 is a flowchart of a method for discharging power to a device, according to an illustrative embodiment of the invention.

### DESCRIPTION OF THE PREFERRED EMBODIMENTS

The present invention relates to systems and methods for adaptive fast-charging for mobile devices and devices having sporadic power-source connection. The principles and operation for providing such systems and methods, according to the present invention, may be better understood with reference to the accompanying description and the drawings.

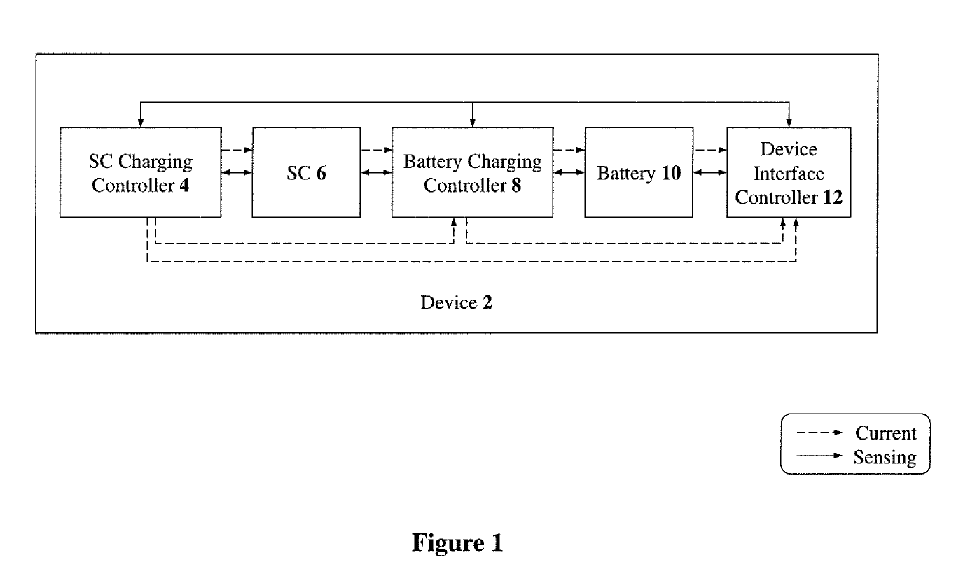

Referring to the drawings, FIG. 1 is a simplified high-level schematic diagram of the device architecture for adaptive fast-charging for mobile devices and devices having sporadic power-source connection, according to preferred embodiments of the present invention. A device 2 (i.e., mobile device or a device having sporadic power-source connection) is shown having a SC charging controller 4, an SC 6, a battery charging controller 8, a rechargeable battery 10, and a device interface controller 12 operationally connected to each other. SC charging controller 4 and battery charging controller 8 each include a charge-sensing element (not shown in FIG. 1) for detecting the level of charge on SC 6 and battery 10, respectively. Charging current flow and charge sensing among the various components are depicted by arrows in FIG. 1.

SC charging controller 4 is responsible for charging preferences of SC 6 and/or battery 10. SC 6 allows for fast charging for operation of device 2, and is responsible for power and energy accumulation. Battery charging controller 8 is responsible for battery charging preferences and current input from SC 6 and/or from SC charging controller 4. Battery 10 is responsible for energy and power accumulation. Device interface controller 12 is responsible for energy and power input preferences for device 2 (e.g., laptop, electric car, and cell-phone).

The device architecture of FIG. 1 enables an optimal contribution of SC 6 and battery 10 to performance of device 2. Such device architecture provides a dramatic improvement of battery power capabilities by decoupling power and energy performance, thus increasing the cycle life of the battery. Fast-charging capability is achieved largely by the high power capacity of SC 6, which can be charged using high current flowing from an external charger (not shown in FIG. 1). After charging of SC 6 is complete, the external charger may be disconnected. Then, battery 10 is charged via the charging current from SC 6. The charge/discharge current flow between SC 6 and battery 10 may be modified according to the indication of SC charging controller 4, battery charging controller 8, and device interface controller 12, thus giving rise to a higher cycle life of device 2.

SC 6 includes an electrolyte and electrodes. The electrodes may be made from activated carbon powders, carbon nanotubes, carbon nanofibres, carbon aerogels, metal oxides, conductive polymers (such as poly aniline, polypyrrole, polythiophene). In addition, several SCs may be connected in series or/and parallel to fomi a composite component represented as SC6.

SC charging controller 4 allows high DC current or pulse current inputs, and enables customized charging preferences (e.g., slow and fast discharge options) between SC 6 and battery 10 when an external charger is connected, while monitoring the accumulated charge on each of SC 6 and battery 10.

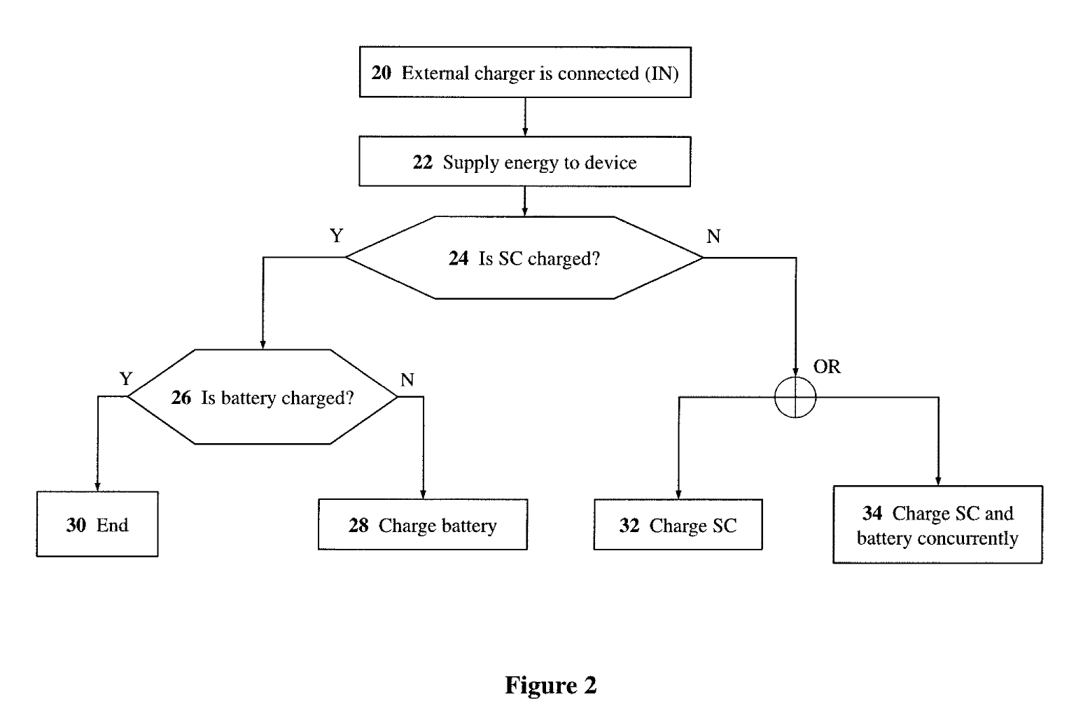

FIG. 2 is a simplified flowchart of the major process steps of an SC controller for adaptive fast-charging for mobile devices and devices having sporadic power-source connection, according to preferred embodiments of the present invention. When an external charger is connected to a power source (IN) (Step 20), energy is supplied from the external charger to device 2 without using the stored energy in SC 6 and/or battery 10 (Step 22). The energy and power needed for device 2 is drawn from the charger itself, but can be also be supplied from SC 6 and/or battery 10.

The charge-sensing element of SC charge controller 4 then determines whether SC 6 is fully charged (Step 24). SC 6 and/or battery 10 receive their charging current from the external charger. The charging current may be continuous current or pulsed. If SC 6 is fully charged, the charge-sensing element of battery charge controller 8 then determines whether battery 10 is fully charged (Step 26). If battery 10 is not fully charged, energy is supplied from the external charger via charging current to battery 10 (Step 28). If battery 10 is fully charged, energy is not supplied from the external charger to battery 10, and the process ends (Step 30). The external charger may only supply the needed energy and power to device 2.

If SC 6 is not fully charged in Step 24, then energy is supplied from the external charger via charging current to SC 6 (Step 32), or supplied concurrently to both SC 6 and battery 10 (Step 34).

Battery charging controller 8 allows adjustable current and/or voltage output, and enables customized charging preferences (e.g., slow and fast discharge options) of battery 10 when the external charger is not connected to a power source (OUT), while monitoring the accumulated charge on each of SC 6 and battery 10. Battery charging controller 8 also serves as an input current/voltage controller via, for example, DC-DC converters (e.g., step-up or step-down transformers).

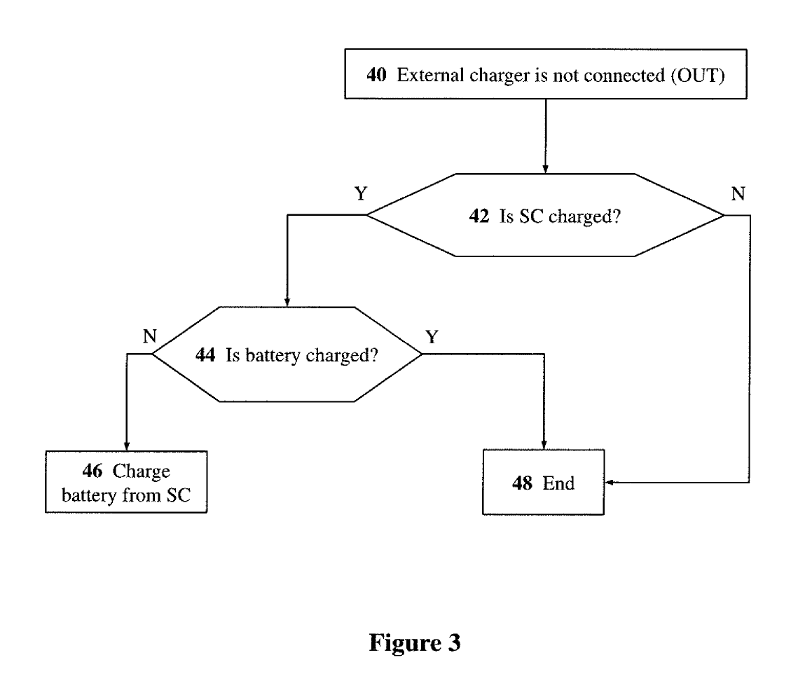

FIG. 3 is a simplified flowchart of the major process steps of a battery controller for adaptive fast-charging for mobile devices and devices having sporadic power-source connection, according to preferred embodiments of the present invention. When an external charger is not connected to a power source (OUT) (Step 40), the charge-sensing element of SC charge controller 4 determines whether SC 6 is fully charged (Step 42). If SC 6 is even partially charged, the charge-sensing element of battery charge controller 8 then determines whether battery 10 is fully charged (Step 44). If battery 10 is not fully charged, battery 8 is charged via charging current from SC 6 (Step 46). If battery 10 is fully charged, or if SC is not charged at all, then the process ends (Step 48).

Device interface controller 12 is responsible for managing and prioritizing the energy and power demands of the load of device 2 with regard to the energy and power supplies via current/voltage regulation.

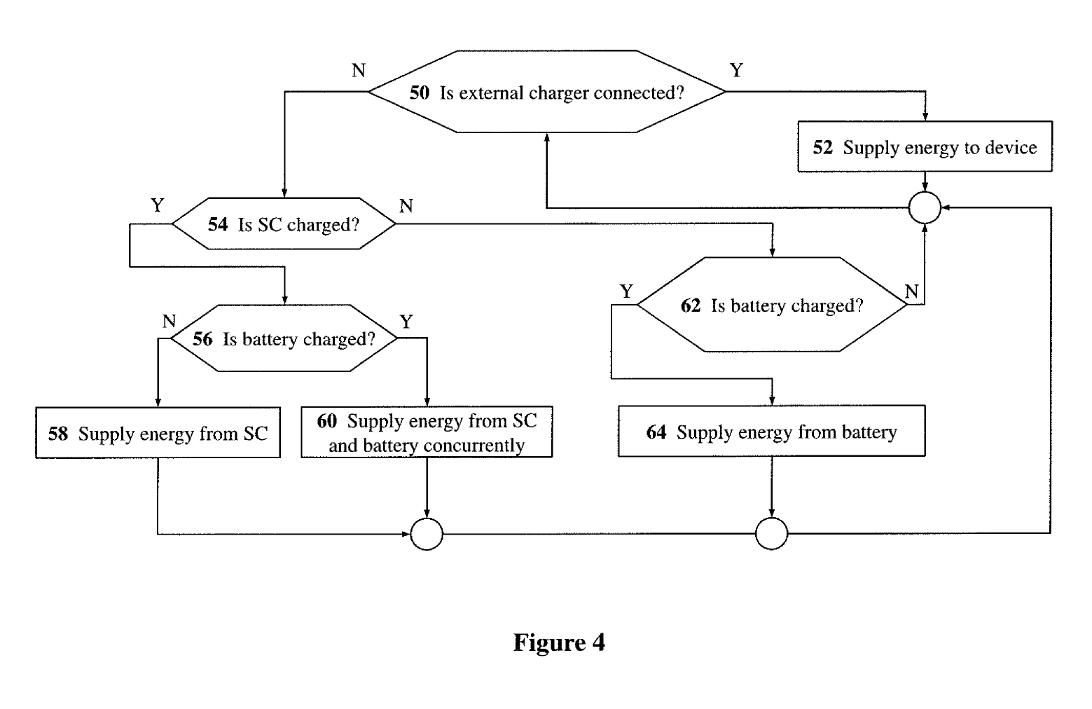

FIG. 4 is a simplified flowchart of the major process steps of a device interface controller for adaptive fast-charging for mobile devices and devices having sporadic power-source connection, according to preferred embodiments of the present invention. Device interface controller 12 determines whether an external charger is connected (Step 50). If an external charger is connected to a power source (IN), then energy and power is supplied from the external charger to device 2 for operation and/or for charging SC 6 and/or battery 10 if they are not fully charged (Step 52), and the process returns to Step 50.

If an external charger is not connected to a power source (OUT), then the charge-sensing element of SC charge controller 4 determines whether SC 6 is even partially charged (Step 54). If SC 6 is even partially charged, then the charge-sensing element of battery charge controller 8 determines whether battery 10 is even partially charged (Step 56). If battery 10 is not charged at all, then power is supplied solely from SC 6 via charging current to device 2 (Step 58), and the process returns to Step 50. If battery 10 is even partially charged in Step 56, then energy and power is supplied concurrently from both SC 6 and battery 10 to device 2 (Step 60), and the process returns to Step 50.

If SC 6 is not charged at all in Step 54, then the charge-sensing element of battery charge controller 8 determines whether battery 10 is even partially charged (Step 62). If battery 10 is even partially charged, then energy and power is supplied solely from battery 10 (Step 64), and the process returns to Step 50. If battery 10 is not charged at all, then the process returns to Step 50.

### Simulations

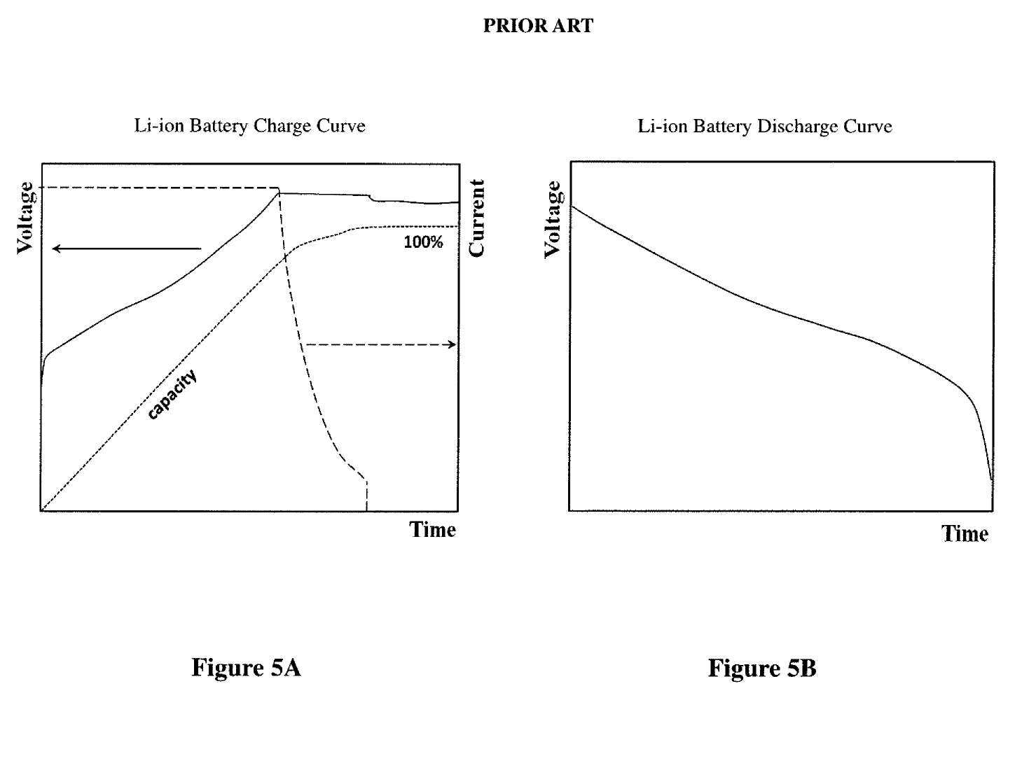

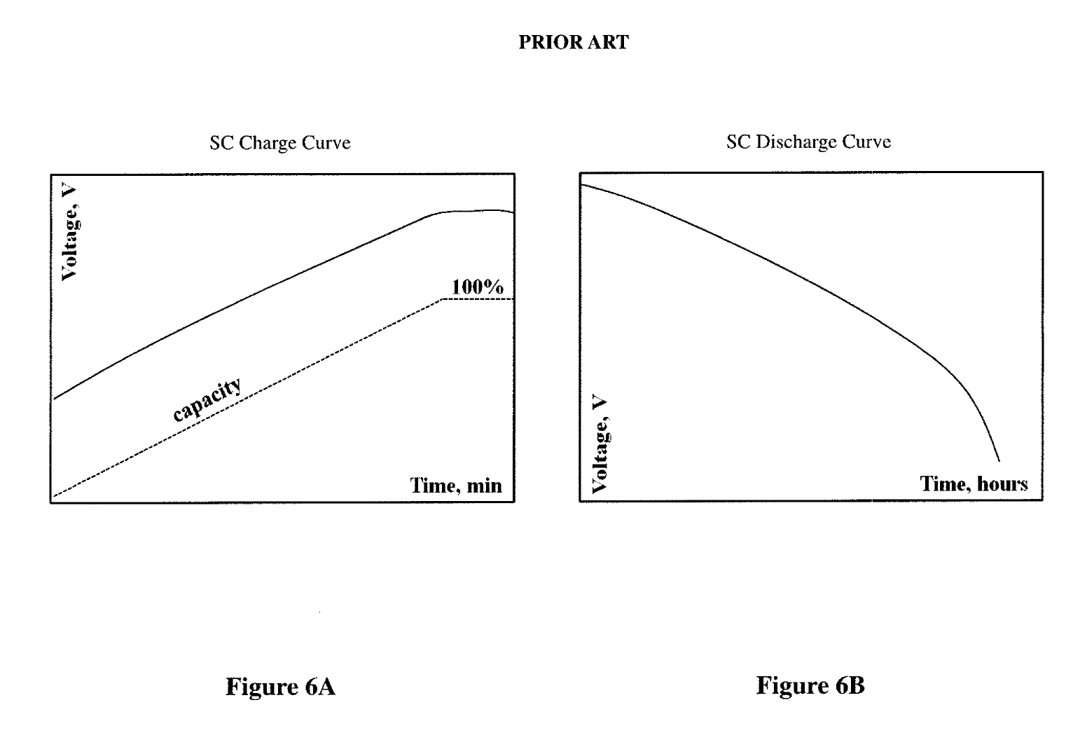

As a reference, FIG. 5A is a graph of a typical Li-ion battery charge curve, and FIG. 5B is a graph of a typical Li-ion battery discharge curve, as known in the prior art. FIG. 6A is a graph of a typical SC charge curve, and FIG. 6B is a graph of a typical SC discharge curve, as known in the prior art.

Unlike batteries, SCs may be charged and discharged at very high current, resulting in fast charge/discharge rates. SCs may be charged by constant current. A DC-to-DC constant current regulator is the simplest form of active charging. Either a buck or boost regulator may be used depending on the application. A buck regulator is the preferred topology due to the continuous output charge current.

The present invention relates to systems and methods for adaptive fast-charging for mobile devices and devices having sporadic power-source connection. Charge/discharge simulations were conducted with a FlashBattery system as follows.
SC charging controller—output voltage: up to 10V; output current: up to 30 A (e.g., LinearTechnology, LT3741)
SC—capacitance C-180F; voltage V=10.8V; energy E=3 Wh; charge time: @30 A, ˜60 sec.
Battery charging controller—input voltage: min 200mV; output voltage: up to 4.5V; output current: up to 1000 mA; Li-ion rechargeable battery; capacity 1500 mAh; voltage V=3.7V; charge time: @500 mA, ˜200 min. or @ 1000 mA, ˜100 min. (LinearTechnology, LTC3105)
Device interface controller—current switch between SC and battery.
Device—constant load: 200 mA (i.e., average current for 3G mobile service for cellphone with 2100 mAh battery and charge for 11 hrs.)

Using FlashBattery parameters listed above, the following simulation data was obtained: (1) SC fully charged within 60 sec; (2) SC discharged down to 0.5% capacity; and (3) battery fully charged within 100 or 200 minutes using 1000 mA and 500 mA, respectively. Details of the simulation parameters are provided below in the following Tables.

TABLE 1
Charge/discharge simulation parameters of FlashBattery
system for 60-sec. charge, with battery charged in
rapid mode using 1000 mA (Simulation #1).

| | SC | Battery | Device | |
|---|---|---|---|---|
| | Charging | Charging | Interface | SC/ |
| Time | Controller | Controller | Controller | Battery |
| t = 0 | External | Battery | Load current | SC = 0%, |
| | charger: | charging: | from | Batt = 0% |
| | IN | OFF | external | |
| | | | charger | |
| t = 60 sec | External | Battery | Load current | SC = 100%, |
| | charger: | charging: | from SC: | Batt = 0% |
| | OUT | ON- | 200 mA | |
| | | 1000 mA | | |
| t~36 min | External | Battery | Load current | SC~0% |
| | charger: | charging: | from battery: | Batt~40% |
| | OUT | OFF | 200 mA | |
| t > 36 min | External | Battery | Load current | Batt < 40% |
| | charger: | charging: | from battery: | |
| | OUT | OFF | 200 mA | |

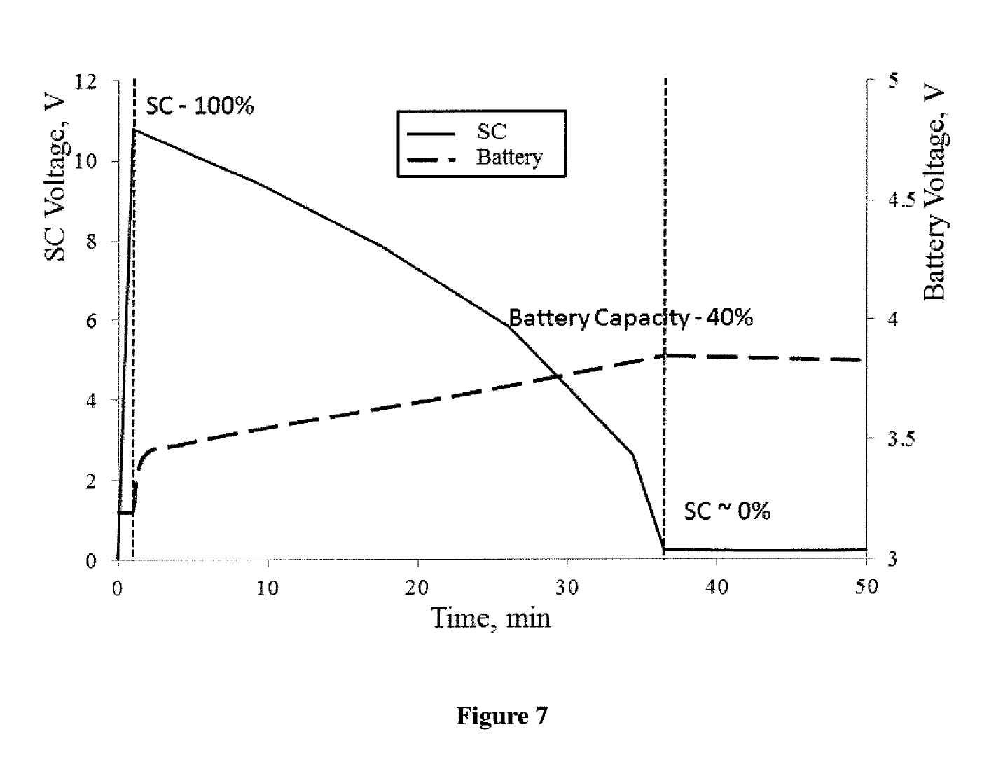

Figure 7 is a graph of a FlashBattery charge-discharge simulation in accordance with the simulation parameters of Table 1, according to preferred embodiments of the present invention.

TABLE 2
Charge/discharge simulation parameters of FlashBattery
system, 100% charged for both SC and battery, with battery
charged in rapid mode using 1000 mA (Simulation #2).

| | SC | Battery | Device | |
|---|---|---|---|---|
| | Charging | Charging | Interface | SC/ |
| Time | Controller | Controller | Controller | Battery |
| t = 0 | External | Battery | Load current | SC = 0%, |
| | charger: | charging: | from | Bat = 0% |
| | IN | OFF | external | |
| | | | charger | |
| t = 60 sec | External | Battery | Load current | SC = 100%, |
| | charger: | charging: | from SC - | Bat = 0% |
| | OUT | ON - | 200 mA | |
| | | 1000 mA | | |
| t~36 min | External | Battery | Load current | SC~0% |
| | charger: | charging: | from battery - | Batt~40% |
| | OUT | OFF | 200 mA | |
| t~60 min | External | Battery | Load current | SC~0% |
| | charger: | charging: | from | Batt~35% |
| | IN | OFF | external | |
| | | | charger | |
| t~61 min | External | Battery | Load current | SC = 100% |
| | Charger | charging: | from SC - | Batt~35% |
| | “OUT” | ON - | 200 mA | |
| | | 1000 mA | | |
| t~97 min | External | Battery | Load current | SC~0% |
| | charger: | charging: | from Battery - | Batt~75% |
| | OUT | OFF | 200 mA | |
| t~120 min | External | Battery | Load current | SC~0% |
| | charger: | charging: | from | Batt~70% |
| | IN | OFF | external | |
| | | | charger | |
| t~121 min | External | Battery | Load current | SC = 100% |
| | charger: | charging: | from SC - | Batt~70% |
| | OUT | ON - | 200 mA | |
| | | 1000 mA | | |
| t~125 min | External | Battery | Load current | SC~80% |
| | charger | Charging: | from SC - | Batt~80% |
| | “OUT” | ON - | 200 mA | |
| | | constant | | |
| | | voltage mode | | |
| | | (<1000 mA) | | |
| t~152 min | External | Battery | Load current | SC~60% |
| | charger: | Charging: | from SC - | Batt = 100% |
| | OUT | OFF | 200 mA | |
| t~153 min | External | Battery | Load current | SC~60% |
| | charger: | Charging: | from | Batt = 100% |
| | IN | OFF | external | |
| | | | charger | |
| t~153 min | External | Battery | Load current | SC = 100% |
| | charger: | charging: | from SC - | Batt = 100% |
| | OUT | OFF | 200 mA | |
| t > 153 min | External | Battery | Load current | SC < 100% |
| | charger: | charging: | from SC - | Batt = 100% |
| | OUT | OFF | 200 mA | |

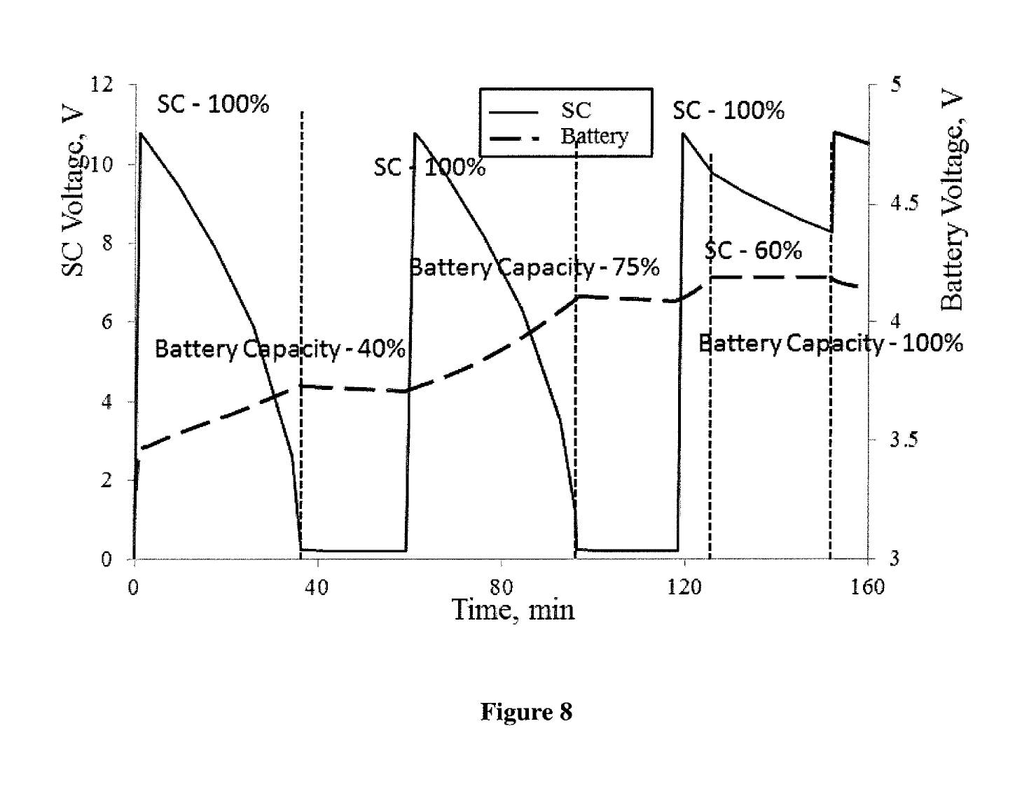

FIG. 8 is a graph of a FlashBattery charge/discharge simulation in accordance with the simulation parameters of Table 2, according to preferred embodiments of the present invention.

TABLE 3
Charge/discharge simulation parameters of FlashBattery system
for 60-sec. charge, operation on battery, with battery charged
in rapid mode using 1000 mA (Simulation #3).

| | SC | Battery | Device | |
|---|---|---|---|---|
| | Charging | Charging | Interface | SC/ |
| Time | Controller | Controller | Controller | Battery |
| t = 0 | External | Battery | Load current | SC = 0%, |
| | charger: | charging: | from | Batt = 0% |
| | IN | OFF | external | |
| | | | charger | |
| t = 60 sec | External | Battery | Load current | SC = 100%, |
| | charger: | charging: | from SC - | Batt = 0% |
| | OUT | ON - | 200 mA | |
| | | 300 mA | | |
| t~36 min | External | Battery | Load current | SC~o% |
| | charger: | charging: | from battery - | Batt~40% |
| | OUT | OFF | 200 mA | |
| t~216 min | External | Battery | Load current | SC~o% |
| | charger: | charging: | from | Batt = 0% |
| | IN | OFF | external | |
| | | | charger | |
| t~217 min | External | Battery | Load Current | SC = 100%, |
| | charger: | charging: | from SC - | Batt = 0% |
| | OUT | ON - | 200 mA | |
| | | 300 mA | | |
| t~253 min | External | Battery | Load current | SC~o% |
| | charger: | charging: | from battery - | Batt~40% |
| | OUT | OFF | 200 mA | |
| t > 253 min | External | Battery | Load current | SC~o% |
| | charger: | charging: | from battery - | Batt < 40% |
| | OUT | OFF | 200 mA | |

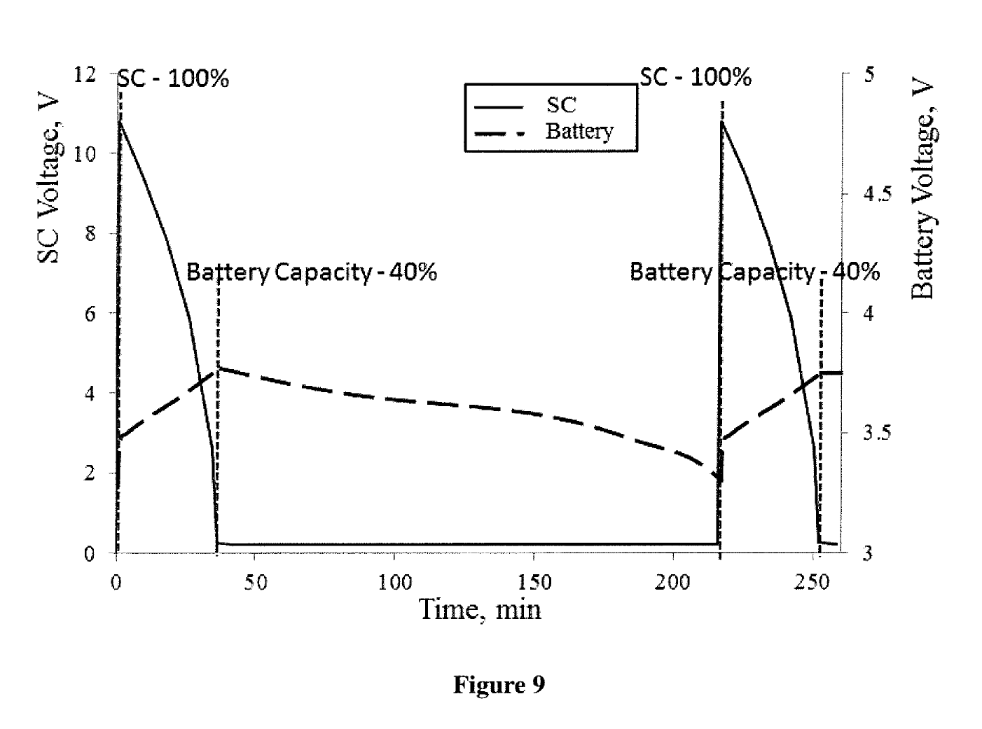

FIG. 9 is a graph of a FlashBattery charge/discharge simulation in accordance with the simulation parameters of Table 3, according to preferred embodiments of the present invention.

TABLE 4
Charge/discharge simulation parameters of FlashBattery system
for low-current battery charge from SC, with battery charged
in low-current mode using 500 mA (Simulation #4).

| | SC | Battery | Device | |
|---|---|---|---|---|
| | Charging | Charging | Interface | SC/ |
| Time | Controller | Controller | Controller | Battery |
| t = 0 | External | Battery | Load current | SC = 0%, |
| | charger: | charging: | from | Batt = 0% |
| | IN | OFF | external | |
| | | | charger | |
| t = 60 sec | External | Battery | Load current | SC = 100%, |
| | charger: | charging: | from SC - | Batt = 0% |
| | OUT | ON - | 200 mA | |
| | | 500 mA | | |
| t~60 min | External | Battery | Load current | SC~o% |
| | charger: | charging: | from battery - | Batt~35% |
| | OUT | OFF | 200 mA | |
| t > 60 min | External | Battery | Load current | SC~o% |
| | charger: | charging: | from battery - | Batt < 35% |
| | OUT | OFF | 200 mA | |

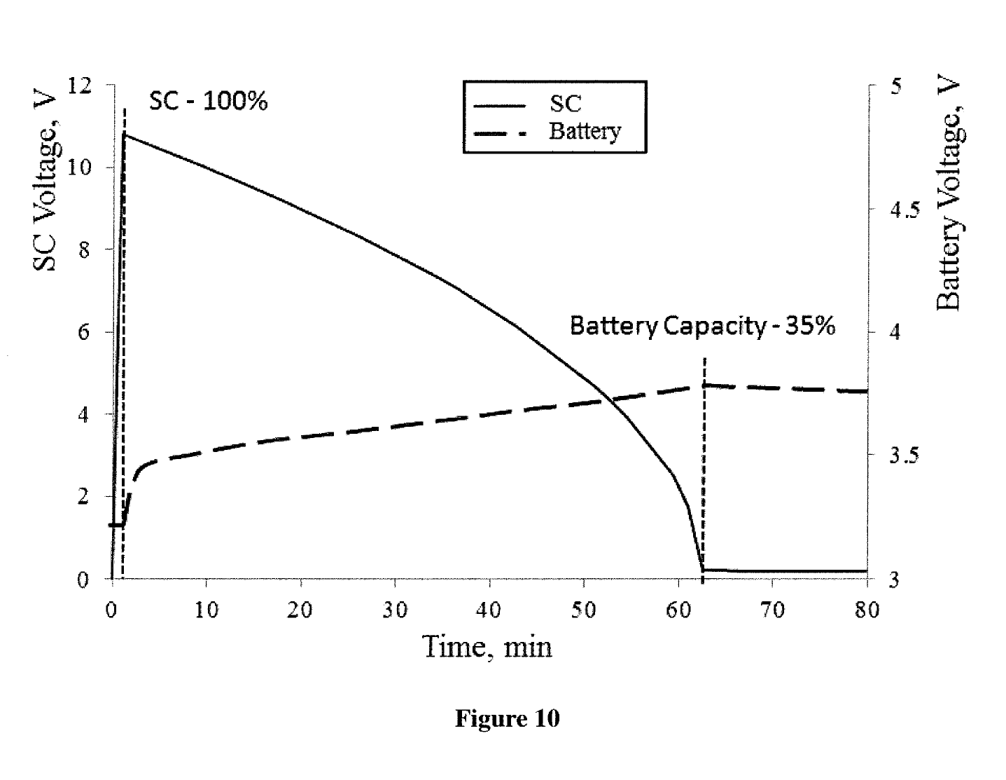

FIG. 10 is a graph of a FlashBattery charge/discharge simulation in accordance with the simulation parameters of Table 4, according to preferred embodiments of the present invention. The low-current mode may be applied during standby time when a device is idle in order to save battery lifetime.

TABLE 5
Charge/discharge simulation parameters of FlashBattery
system, 100% charged from external charger, with battery
charged in rapid mode using 1000 mA (Simulation #5).

| | SC | Battery | Device | |
|---|---|---|---|---|
| | Charging | Charging | Interface | SC/ |
| Time | Controller | Controller | Controller | Battery |
| t = 0 | External | Battery | Load current | SC = 0%, |
| | charger: | charging: | from charger - | Batt = 0% |
| | IN | OFF | 200 mA | |
| t = 60 sec | External | Battery | Load current | SC = 100%, |
| | charger: | charger: | from charger - | Batt = 0% |
| | IN | ON - | 200 mA | |
| | | 1000 mA | | |
| t = 101 min | External | Battery | Load current | SC = 100%, |
| | charger: | charging: | from SC - | Batt = 100% |
| | OUT | OFF | 200 mA | |
| t > 101 min | External | Battery | Load current | SC < 100%, |
| | charger: | charging: | from SC - | Batt = 100% |
| | OUT | OFF | 200 mA | |

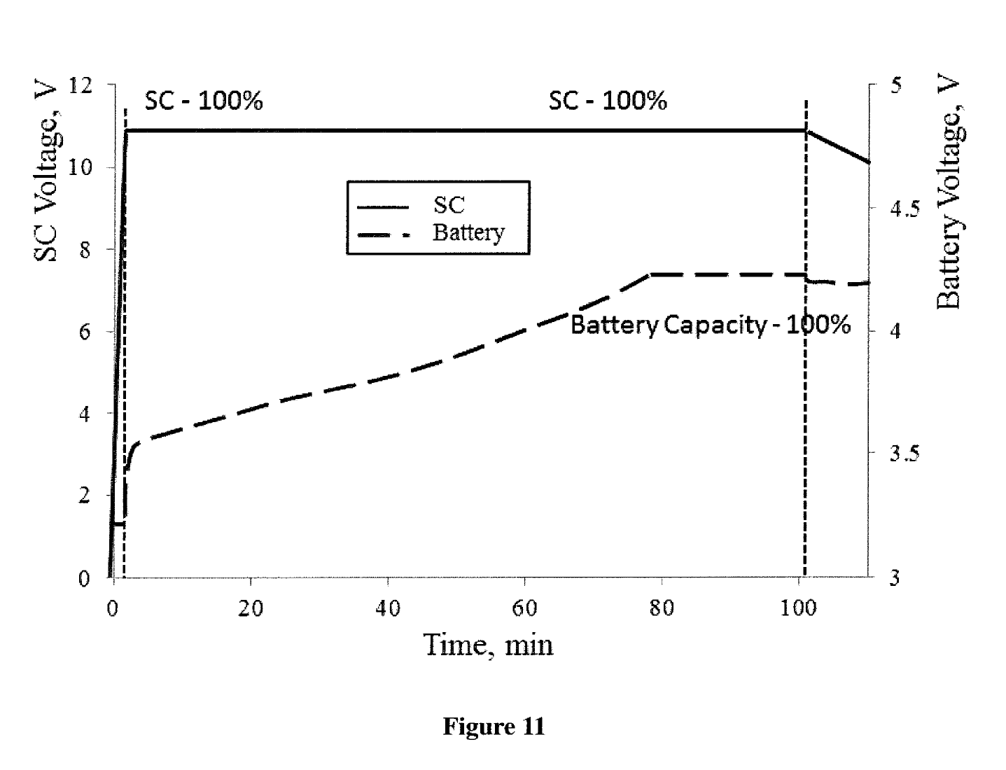

FIG. 11 is a graph of a FlashBattery charge/discharge simulation in accordance with the simulation parameters of Table 5, according to preferred embodiments of the present invention.

Simulation Summary

Table 6 compares the results from the FlashBattery system with a standard cellphone battery.

TABLE 6
Charge/discharge simulation parameters of FlashBattery
system with combination SC and battery configuration.

| | | |
|---|---|---|
| | Standard Cell- | SC (3 Wh) |
| Performance | phone battery | & Battery |
| Parameters | (2500 mAh) | (1500 mAh) |

| Charging time | 2.5-4 | hrs. | 60 | sec. |
|---|---|---|---|---|
| Operation time | ~11 | hrs. | ~3.5 | hrs. |
| (200 mA | | | | |
| constant load) | | | | |
| Recharge interval | <11 | hrs. | ~35 | min. |
| | | | (after SC discharge) | |
| Operation time after | <11 | hrs. | 3.5-11 | hrs. |
| recharge (200 mA | | | | |
| constant load) | | | | |

In such a case, the FlashBattery system provides device power from an SC and battery with flexible and convenient adaptive fast-charging capabilities, resulting in long operation time. Moreover, smart battery charging is enabled by controlling the current, allowing adaptation of the system to user requirements.

In some embodiments, devices having intermittent power source connectivity can include a fast charging battery cell having a first charge rate that is coupled to a secondary battery having a second charge rate. The first charge rate can be less than the second charge rate. The fast charging battery cell can receive power from an external power source at the first charge rate, and then provide power to the second battery at the second charge rate. The first charge rate can be higher than the second charge rate of the second battery. For example, the first charge rate can be 5 C to and/or the second charge rate can be 0.5 C to 1 C. In this manner, a device can be quickly charged when connected to an external power source due to, for example, the fast charging battery cell, and/or simultaneously allow for the fast charging battery cell to have less capacity and/or be less expensive than current devices that only include a fast charging battery cell.

Some embodiments of the invention can enable adaptive fast-charging of mobile devices and/or devices having a sporadic power-source. The invention can include a charging apparatus that includes a high-power fast charging battery cell that can be charged to a first charge capacity (e.g., about 70% of rated capacity of the fast charging battery cell) in a first time period (e.g., 5 minutes), or second charge capacity (e.g., about 95% of rated capacity of the fast charging battery cell) in a second time period (e.g., 30 minutes), or third charge capacity (e.g., about 100% of rated capacity of the fast charging battery cell) for more than a third time period (e.g., 30 min). The fast charging battery cell can be coupled to other rechargeable batteries. This can allow for higher system power, while preserving energy density of the overall system level battery in a device-compatible form factor.

In some embodiments, the first, second and/or third charge capacity is based on specifications (e.g., voltage level) of the fast charging battery cell and/or the rechargeable batteries. In various embodiments, the number of segments and the capacity and/or time period of each segment is configurable.

In some embodiments, the fast charging battery cell is of the same type as the rechargeable battery.

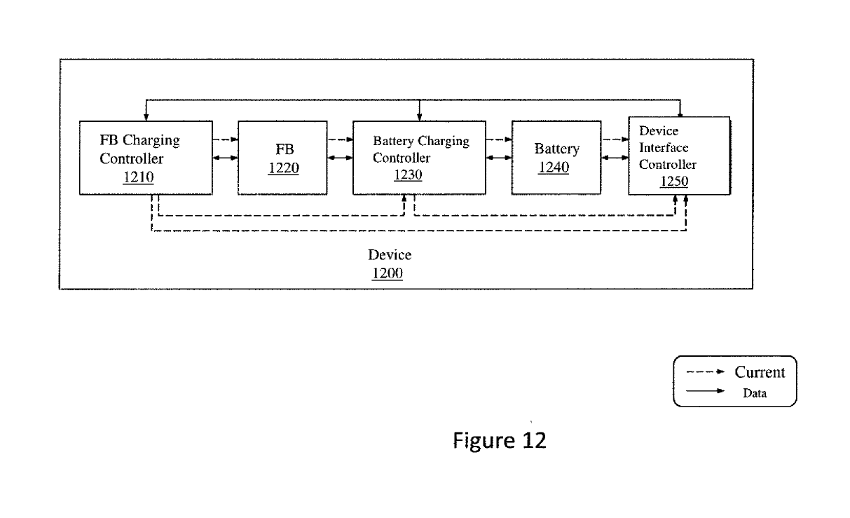

FIG. 12 is a schematic diagram of an architecture for a device 1200 for providing power to the device, according to an illustrative embodiment of the invention. The device 1200 includes a fast charging battery cell (F13) controller 1210, a FB 1220, a secondary battery controller 1230, a secondary battery 1240, and a device interface controller 1250.

The FB controller 1210 is coupled to the FB 1220, the secondary battery controller 1230, and the device interface controller 1250 via current and data connections. The secondary battery controller 1230 is coupled to the secondary battery 1240, the FB charging controller 1210, and the device interface controller 1250 via current and data connections. In some embodiments, the FB 1220 is a battery as is described in U.S. patent application Ser. No. 14/926,012 filed on Oct. 29, 2015, incorporated herein by reference it its entirety.

In some embodiments, the FB controller 1210 can be coupled to an exterior power source (not shown). In some embodiments, the FB controller 1210 includes an analog to digital converter, a current source and/or a power source. In some embodiments, the FB controller 1210 includes elements as are known in the art to control power.

In some embodiments, the secondary battery controller 1230 includes an analog to digital converter, a current source and/or a power source. In some embodiments, the secondary battery controller 1230 includes elements as are known in the art to control power.

In some embodiments, the FB controller 1210 and the secondary battery controller 1230 are positioned in the same chip. In some embodiments, the FB controller and the secondary battery controller are positioned on separate chips.

During operation, the FB controller 1210 can control charging and/or discharging of the FB 1210. The FB controller 1210 can also transmit data (e.g., charge state of the FB 1210) for the battery charging controller 1230 and/or the device interface controller 1250. The secondary battery charging controller 1230 can control charging and/or discharging of the secondary battery 1240.

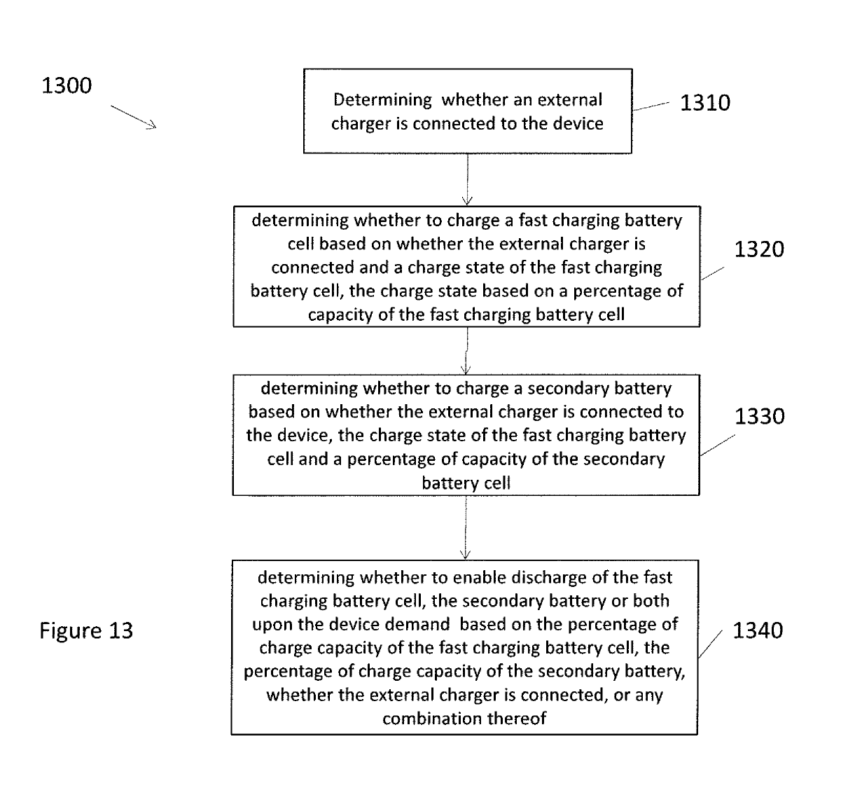

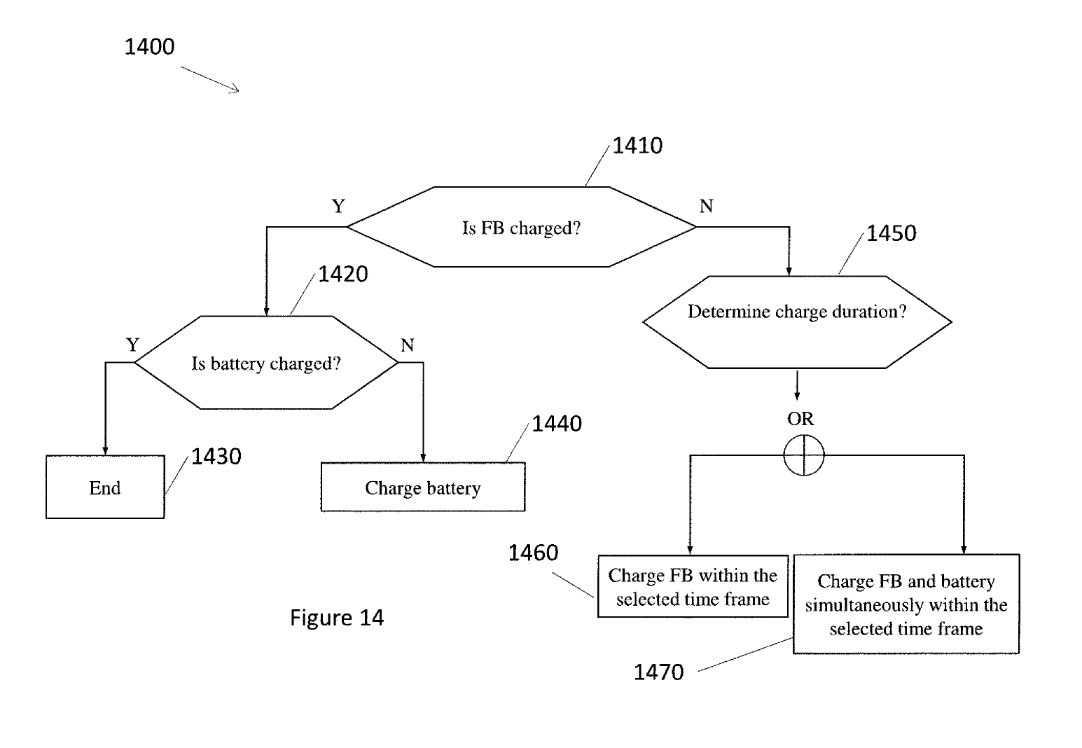

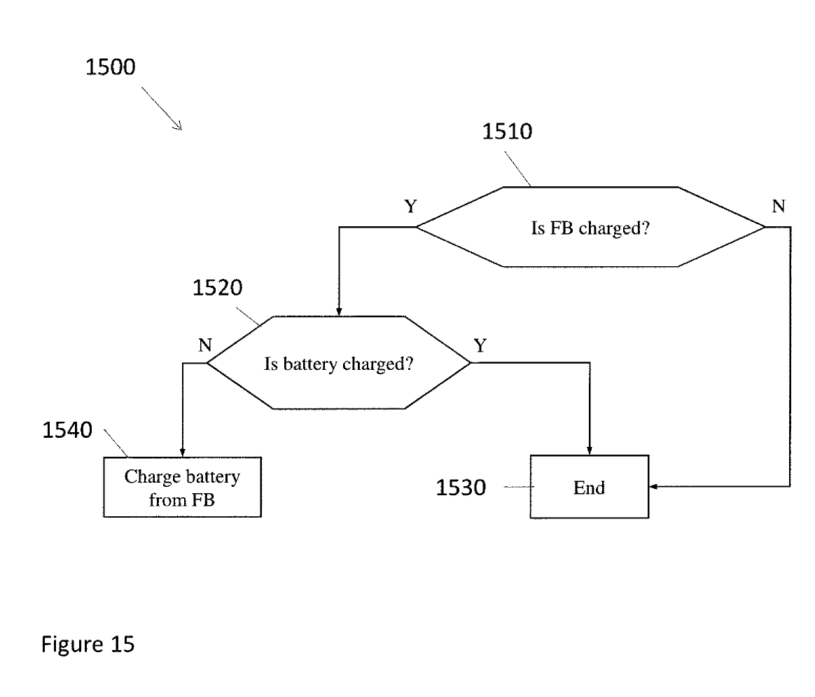

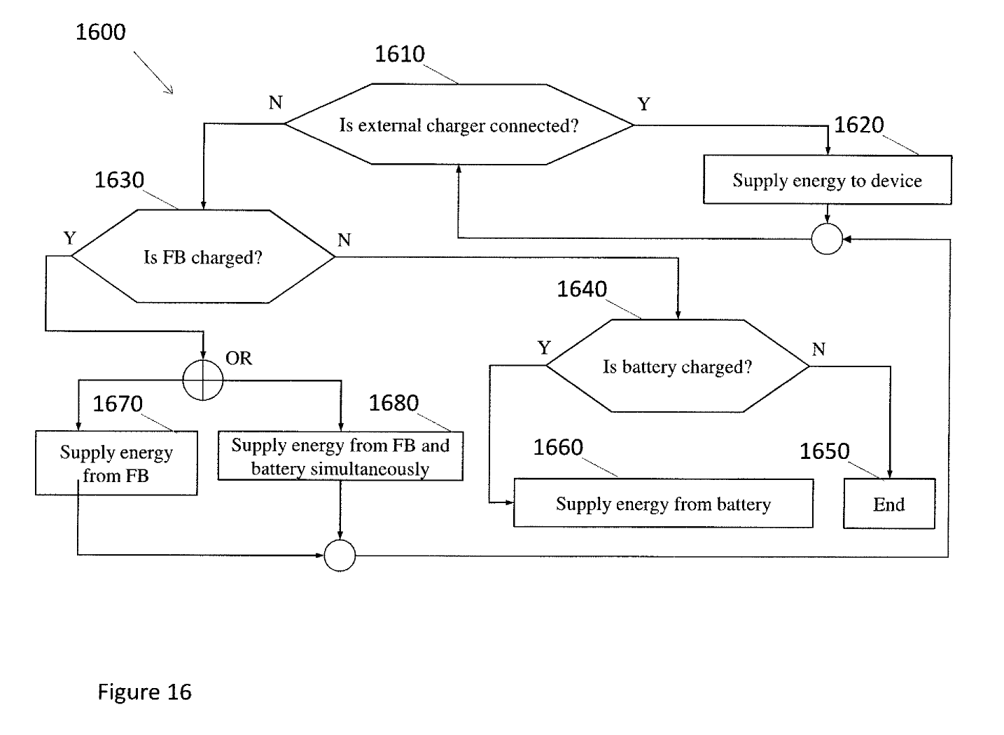

The FB controller 1210 and the secondary battery charger controller 1230 can control charging and/or discharging in accordance with the methods described in FIG. 13, FIG. 14, FIG. 15 and/or FIG. 16, as are described in further detail below.

FIG. 13 is a flowchart 1300 of a method for providing power to a device (e.g., device 1200 as described above in FIG. 12), according to an illustrative embodiment of the invention. The method involves determining whether an external charger is connected to the device (Step 1310). The external charger can include a connection to an AC wall outlet, a connection to an external battery source, or any combination thereof.

The method also involves determining whether to charge a FB (e.g., FB 1220 as described above in FIG. 12) based on whether the external charger is connected and a charge state of the FB (Step 1320). The charge state can be based on a percentage of charge capacity of the FB (e.g., voltage in the FB), a temperature of the FB, a resistance of the FB, and/or an amount of an input from the external charger.

The method also involves determining whether to charge a secondary battery (e.g., secondary battery 1240 as described above in FIG. 12) based on whether the external charger is connected to the device, a charge state of the FB, and a charge state of the secondary battery (Step 1330). The charge state of the secondary battery can be based on a percentage of charge capacity of the secondary battery, a temperature of the secondary battery, a resistance of the secondary battery, and/or an amount of an input from the external charger.

The method also involves determining whether to discharge the FB cell, the secondary battery or both to the device based on the percentage of charge capacity of the fast charging battery cell (e.g., voltage in the secondary battery), the percentage of charge capacity of the secondary battery, whether the external charger is connected, or any combination thereof (Step 1340).

FIG. 14 is a flowchart of a method 1400 for charging batteries of a device (e.g., device 1200 as described above in FIG. 12) when the device is connected to an external power source, according to an illustrative embodiment of the invention. The method involves determining if a FB (e.g., FB 1220 as described above in FIG. 12) of the device is charged (Step 1410). The determination can be performed by an FB controller (e.g., FB controller 1210, as described above in FIG. 12). The determination can be based on a percentage of charge capacity of the FB (e.g., voltage in the FB), a temperature of the FB, a resistance of the FB, and/or an amount of an input from the external charger.

The method also involves, if the FB is charged, then determining whether a secondary battery (e.g., secondary battery 1240 as described above in FIG. 12) of the device is charged (Step 1420). The determination can be based on a percentage of charge capacity of the secondary battery, a temperature of the secondary battery, a resistance of the secondary battery, and/or an amount of an input from the external charger.

The method also involves, if the secondary battery is charged, the method can end (Step 1430). If the secondary battery not charged, then the secondary battery can be charged (Step 1440). In some embodiments, the secondary battery is charged for a predetermined time. For example, a user may specify a charge duration of 20 minutes. In this example, the secondary battery is charged for 20 minutes or until the secondary batter is fully charged, whichever comes first. In some embodiments, the secondary battery is charged to reach a predetermined percentage of its charge capacity. For example, a user may specify that the secondary battery be charged to 90% of its charge capacity. In this example, the predetermined percentage of its charge capacity is 90%. In some embodiments, the predetermined percentage is based on a type of the secondary battery. In some embodiments, the predetermined percentage is based on preserving the lifetime of the secondary battery.

The method also involves, if the FB is not charged, determining a charge duration (e.g., a number of minutes to charge) (Step 1450). In some embodiments, the charge duration is input by a user. The method also involves i) charging the FB (Step 1460) or ii) charging the FB and the secondary battery within the number of minutes to charge (Step 1470). In some embodiments, the charge duration is based on a type battery of the FB, a type of battery of the secondary battery, or any combination thereof. In some embodiments, the charge duration substantially equals an amount of time it takes for the FB to charge. In some embodiments, the time duration is longer than the duration it takes to charge the FB. In this embodiment, a cycle life of the FB can be extended.

In some embodiments, whether to charge the FB or charge both the FB and the secondary battery is based on the time duration, the percentage of charge capacity of the F13, and/or the percentage of charge capacity of the secondary battery. For example, a user may only have a certain time duration for the charging (e.g., a user may need to board a train in 10 minutes). In this example, it may take longer than 10 minutes to charge the F13 and the secondary battery to their fullest charge capacity, however it may be possible to charge the FB to its fullest capacity. In this example, if the secondary battery has a percentage of charge capacity that is greater than a predefined threshold (e.g., fully charged or almost fully charged), then it may be desirable to only charge the FB such that the FB is charged to its fullest capacity.

In some embodiments, an amount of current needed to charge the FB within the time duration may be less than the total current available from an external charger. In these embodiments, the FB and the secondary battery can be charged simultaneously.

In some embodiments, an amount and/or time duration to charge the FB and/or secondary capacity can be based on a charge duration as specified as shown in Table 6 below.

TABLE 6

| Charge | FB fully discharged | FB partially discharged | FB fully charged |
|---|---|---|---|
| Duration | (e.g., below 6% charged) | (e.g., below 50% charged) | (e.g., above 94% charged) |
| 5 Minutes | Charge the FB to | Charge the FB to 70% of | Charge the secondary |
| | 70% of capacity, | capacity without charging | battery with low cur- |
| | OR charge FB | the secondary battery and | rent for 5 minutes or up |
| | and the secondary | then charge the | to 100% of the secondary |
| | battery | secondary battery with | battery capacity |
| | | low current for the rest | |
| | | of the time if needed | |
| | | (up to 5 minutes) | |
| 30 Minutes | Charge the FB to | Charge the FB to 95% of | Charge the battery |
| | 95% OR charge FB | capacity without charging | with low current |
| | and the battery | secondary the battery and | for 30 minutes or |
| | | then charge the | up to 100% of the |
| | | secondary battery with | battery capacity |
| | | low current for the rest | |
| | | of the time if needed | |
| | | (e.g., up to 30 minutes) | |
| More than | Charge the FB to | Charge the FB to 100% of | Charge the battery with |
| 30 minutes | 100% OR charge FB | capacity, without charging | low current for more |
| | and the secondary | the battery and | than 30 minutes or up to |
| | battery | then charge the | 100% of the secondary |
| | | secondary battery with | battery capacity |
| | | low current for the rest | |
| | | of the time if needed | |
| | | (up to 30 minutes) | |

FIG. 15 is a flowchart of a method 1500 for charging batteries of a device (e.g., device 1200 as described above with respect to FIG. 12) when the device is not connected to an external power source, according to an illustrative embodiment of the invention. The method 1500 involves determining if a FB (e.g., FB 1220 as described above in FIG. 12) of the device is charged (Step 1510). The determination can be based on a percentage of charge capacity of the FB, as described above with respect to FIG. 14.

The method also involves, if the FB is charged, determining whether a secondary battery (e.g., secondary battery 1240 as described above in FIG. 12) of the device is charged (Step 1520). The determination can be based on a percentage of charge capacity of the secondary battery, as described above with respect to FIG. 14. The method also involves ending the method if the secondary battery is charged (Step 1530). The method also involves charging the secondary battery if the secondary battery is not charged (Step 1540).

The method also involves if the FB is not charged ending the method (Step 1540). In this manner, when the device is not connected to an external power source, the FB, if charged can provide power to the secondary battery to power the device.

FIG. 16 is a flowchart of a method 1600 for discharging power to a device (e.g., device 1200 as described above with respect to FIG. 12), according to an illustrative embodiment of the invention. The method involves determining if an external charger is connected to the device (Step 1610).

The method also involves, if an external power source is connected, then supply power to the device from the external power source (Step 1620). The method also involves determining if a FB of the device is charged (Step 1630). The determination can be based on a percentage of charge capacity of the FB, as described above with respect to FIG. 14.

The method can also involve, if the FB is not charged, determining if a secondary battery (e.g., secondary battery 1240 as described above in FIG. 12) of the device is charged (Step 1640). The determination can be based on a percentage of charge capacity of the secondary battery, as described above with respect to FIG. 14. The method can also involve, ending the method if the secondary battery is not charged (Step 1650). The method can also involve, if the secondary battery is charged, supplying power from the secondary battery to the device (Step 1660).

In some embodiments, if the secondary battery is not charged, the FB discharges its charge to the secondary battery. In some embodiments, the discharge is performed as rapidly as possible by controlling a current to the secondary battery. The max discharge current of the fast charging battery cell can be, for example: Iₘₐₓ_{_}_{dsch}=0.5 C_{RB}—current consumption of the device each moment, where C_{RB} is the charge capacity of rechargeable battery.

The method can also involve, if the FB is charged, i) supplying power from the FB to the device (Step 1670), or ii) supplying power from the F13 and the secondary battery (Step 1680). In some embodiments, whether to supply power from the FB or the FB and secondary battery is based on a percentage of charge capacity of the FB and the secondary battery, respectively. For example, if the secondary battery has a percentage of charge capacity that is less than a predefined threshold (e.g., 5%), then power can be supplied from the FB only. In another example, if a load of the device is greater than percentage of charge capacity left in the FB, then the power can be supplied from the FB and the secondary battery. For example, the F13 and the secondary battery can each include regions of the cell that are ideal for extracting energy from to preserve a lifetime of the battery. In this example, it can be desirable to pull energy from both batteries such that energy is pulled from the ideal regions first. In some embodiments, power supplied from the FB and/or secondary battery is determined as shown in Table 7 below.

TABLE 7

| | | Battery | Device | |
|---|---|---|---|---|
| | FB Charging | Charging | Interface | FB/ |
| Time | Controller | Controller | Controller | Battery |
| t = 0 | External | Battery | Load current | FB = 0%, |
| | charger: IN 1^{st} | charging: | from | Batt = 0% |
| | segment selected | OFF | external | |
| | (5 min | | charger | |
| | time frame) | | | |
| t = 5 min | External | Battery | Load current | FB = 70%, |
| | charger: | charging: | from FB - | Batt = 0% |
| | OUT | ON - | 200 mA | |
| | | 300 mA | | |
| t~185 min | External | Battery | Load current | FB~0% |
| | charger: | charging: | from battery - | Batt~23% |
| | OUT | OFF | 200 mA | |
| t~290 min | External | Battery | Load current | FB~0% |
| | charger: IN 2^{nd} | charging: | from | Batt = 0% |
| | segment selected | ON - | external | |
| | (30 min | 300 mA | charger | |
| | time frame) | | | |
| t~320 min | External | Battery | Load Current | FB = 95%, |
| | charger: | charging: | from battery - | Batt = 40% |
| | OUT | ON - | 200 mA | |
| | | 300 mA | | |
| t~605 min | External | Battery | Load current | FB~0% |
| | charger: | charging: | from battery - | Batt~48% |
| | OUT | OFF | 200 mA | |

Table 7 shows an example of various powers supplied for a FB and secondary battery have an equal capacity of 100 mAmps over time. Assuming initial conditions of the FB and the secondary battery are not charged, an external charger is connected and the device receives current from the external charger. After 5 minutes of being connected to the external charger, assuming the external charger is removed, the FB is at 70% charging capacity, the secondary battery is not charged. The secondary battery controller turns on Assuming the device has a load of ˜200 mA, the FB provides ˜200 mA to the secondary battery and 300 mA to the secondary battery. After another 180 minutes (t=185 minutes), assuming the external charger has not been reconnected, the FB is not charged, the secondary battery has 23% capacity and the secondary battery provides ˜200 mA to the secondary battery. As is apparent to one of ordinary skill in the art, the percentage that the FB and secondary battery are charged and/or discharged depends on the load of the device, and the current provided by the external charger.

While the present invention has been described with respect to a limited number of embodiments, it will be appreciated that many variations, modifications, and other applications of the present invention may be made.

What is claimed is:

1. A method for supplying power to a device, the method comprising:
determining whether an external charger is connected to the device;
determining whether to charge a fast charging battery cell based on whether the external charger is connected and a charge state of the fast charging battery cell, the charge state based on a percentage of charge capacity of the fast charging battery cell;
determining whether to charge a secondary battery based on whether the external charger is connected to the device, the charge state of the fast charging battery cell and a percentage of charge capacity of the secondary battery; and
determining whether to enable discharge of the fast charging battery cell, the secondary battery or both upon the device demand based on the percentage of charge capacity of the fast charging battery cell, the percentage of charge capacity of the secondary battery, whether the external charger is connected, or any combination thereof.

2. The method of claim I wherein charging the fast charging battery cell or charging the secondary battery cell further comprises charging the fast charging battery cell or charging the secondary battery cell for a predetermined time, to a predetermined capacity, or any combination thereof.

3. The method of claim 2 wherein the predetermined time and/or the predetermined capacity is input by a user of the device.

4. The method of claim 2 wherein charging the fast charging battery cell further comprises:
receiving the predetermined charge time from user input, a computer file, or any combination thereof.

5. The method of claim 2 wherein charging the fast charging battery cell further comprises:
receiving the predetermined capacity from user input, a computer file, or any combination thereof.

6. The method of claim 1 wherein if the external charger is connected the fast charging battery cell and the secondary battery are not discharged.

7. The method of claim 1 wherein if the external charger is not connected and the fast charging battery cell is at least partially charged, then a percentage to discharge the fast charging battery cell and percentage to discharge the secondary battery is based on a predetermined time duration.

8. A system for charging a device, the system comprising:
a fast charging battery cell coupled to the device and to receive a charge from an external power source;
a fast charging battery cell controller coupled to the fast charging battery to control an amount of current supplied to the fast charging battery;
a secondary battery coupled to the fast charging battery cell and the device, the secondary battery to receive current from the fast charging battery cell and to provide current to the device; and
a secondary battery controller coupled to the fast charging battery controller and the secondary battery to control an amount of current supplied to the secondary battery.

9. The system of claim 8 wherein the fast charging battery cell is configured to receive a charge rate of at least 5 C.

10. The system of claim 8 wherein the fast charging battery cell controller and the secondary battery controller are positioned in the same chip.
